(19) United States
(12) Patent Application Publication
(10) Pub. No.: US 2026/0029746 A1
(43) Pub. Date: Jan. 29, 2026

(54) IMAGE FORMING APPARATUS

(71) Applicant: CANON KABUSHIKI KAISHA, Tokyo (JP)

(72) Inventors: YASUZUMI TABA, Shizuoka (JP); KAYO USUI, Shizuoka (JP); HIROSHI KAWAGUCHI, Shizuoka (JP)

(21) Appl. No.: 19/264,603

(22) Filed: Jul. 9, 2025

(30) Foreign Application Priority Data
Jul. 23, 2024 (JP) 2024-117439

(51) Int. Cl. G03G 21/16; G03G 15/00; G03G 21/18

(52) U.S. Cl. CPC G03G 21/1647; G03G 15/6529; G03G 21/1633; G03G 21/1842; G03G 2221/1639; G03G 2221/1642; G03G 2221/169

(57) ABSTRACT

An image forming apparatus includes an apparatus body including an opening portion, an detachable unit, a door, and a holding member including a first end portion connected to the apparatus body and a second end portion connected to the door, the holding member being configured to move together with the door and to hold the door positioned at the open position. The holding member is movable from a first position to a second position in a state where the door is positioned at the open position, the first position being a position at which the holding member overlaps with an attachment-and-detachment trajectory of the detachable unit, the second position being a position at which the holding member does not overlap with the attachment-and-detachment trajectory of the detachable unit and allows the detachable unit to be attached to and detached from the apparatus body.

### BACKGROUND

### Field of the Technology

The present disclosure relates to an image forming apparatus that forms images on sheets.

### Description of the Related Art

Japanese Patent Application Publication No. 2018-4800 discloses an image forming apparatus that includes a door that can be opened and closed with respect to an apparatus body, and a strap that connects the apparatus body and the door. The strap regulates the opening angle of the door in a state where the door is opened, and is disposed outside the attachment-and-detachment trajectory of an intermediate transfer unit that can be replaced.

However, since the strap disclosed in Japanese Patent Application Publication No. 2018-4800 is disposed outside the attachment-and-detachment trajectory of the intermediate transfer unit so as not to restrict the attachment and detachment of the intermediate transfer unit, the strap restricts the image forming apparatus from being downsized.

### SUMMARY

An object of the present disclosure is to provide an image forming apparatus that can be downsized while providing good workability for attaching and detaching the detachable unit.

According to a first aspect of the present disclosure, an image forming apparatus configured to form an image on a sheet, the image forming apparatus includes an apparatus body including an opening portion, an detachable unit configured to be attached to and detached from the apparatus body via the opening portion, a door openably and closably supported by the apparatus body and configured to move between a closed position at which the door closes the opening portion and an open position at which the door opens the opening portion, and a holding member including a first end portion connected to the apparatus body and a second end portion connected to the door, the holding member being configured to move together with the door and to hold the door positioned at the open position. The holding member is movable from a first position to a second position in a state where the door is positioned at the open position, the first position being a position at which the holding member overlaps with an attachment-and-detachment trajectory of the detachable unit, the second position being a position at which the holding member does not overlap with the attachment-and-detachment trajectory of the detachable unit and allows the detachable unit to be attached to and detached from the apparatus body.

According to a second aspect of the present disclosure, an image forming apparatus configured to form an image on a sheet, the image forming apparatus includes an apparatus body including an opening portion, an detachable unit configured to be attached to and detached from the apparatus body via the opening portion, a door openably and closably supported by the apparatus body and configured to move between a closed position at which the door closes the opening portion and an open position at which the door opens the opening portion, and a guide member attachably and detachably supported by the door and configured to guide a sheet in a case where the door is positioned at the closed position. At least a portion of the guide member is configured to overlap with an attachment-and-detachment trajectory of the detachable unit in a state where the guide member is attached to the door positioned at the open position, the guide member being configured to be retracted from the attachment-and-detachment trajectory by the guide member being detached from the door.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating a printer of a first embodiment.

FIG. 2 is a perspective view illustrating the printer in a state where a back door is opened.

FIG. 3A is a back view illustrating the interior of the printer in a state where the back door is opened.

FIG. 3B is an enlarged perspective view illustrating a broken-line portion D of FIG. 3A.

FIG. 4A is a cross-sectional view illustrating a configuration of surroundings of first end portion of a holding member.

FIG. 4B is a cross-sectional view illustrating a state where the first end portion of the holding member is being disconnected.

FIG. 5 is a perspective view illustrating a state where a fixing apparatus is being detached from the apparatus body.

FIG. 6 is a perspective view illustrating a printer of a first modification of the first embodiment.

FIG. 7 is a perspective view illustrating a printer of a second modification of the first embodiment.

FIG. 8 is a back view illustrating a printer of a third modification of the first embodiment.

FIG. 9 is a back view illustrating a printer of a fourth modification of the first embodiment.

FIG. 10A is a perspective view illustrating a printer of a fifth modification of the first embodiment.

FIG. 10B is a back view illustrating the printer of the fifth modification of the first embodiment.

FIG. 11A is a perspective view illustrating a printer of a sixth modification of the first embodiment.

FIG. 11B is a back view illustrating the printer of the six modification of the first embodiment.

FIG. 12 is a perspective view illustrating a printer of a second embodiment.

FIG. 13 is a back view illustrating the interior of the printer in a state where a back door is opened.

FIG. 14 is a plan view illustrating a guide member and the back door.

FIG. 15A is an enlarged perspective view illustrating a broken-line portion N of FIG. 14.

FIG. 15B is a cross-sectional view of the broken-line portion N of FIG. 14.

FIG. 16 is an enlarged perspective view illustrating a broken-line portion P of FIG. 14.

FIG. 17A is a cross-sectional view illustrating a state where a tab of the guide member fits in a boss of the back door.

FIG. 17B is a cross-sectional view illustrating a state where the tab of the guide member is being separated from the boss of the back door.

FIG. 18 is a perspective view illustrating a state where the guide member is detached from the back door.

### DESCRIPTION OF THE EMBODIMENTS

### First Embodiment

### Overall Configuration

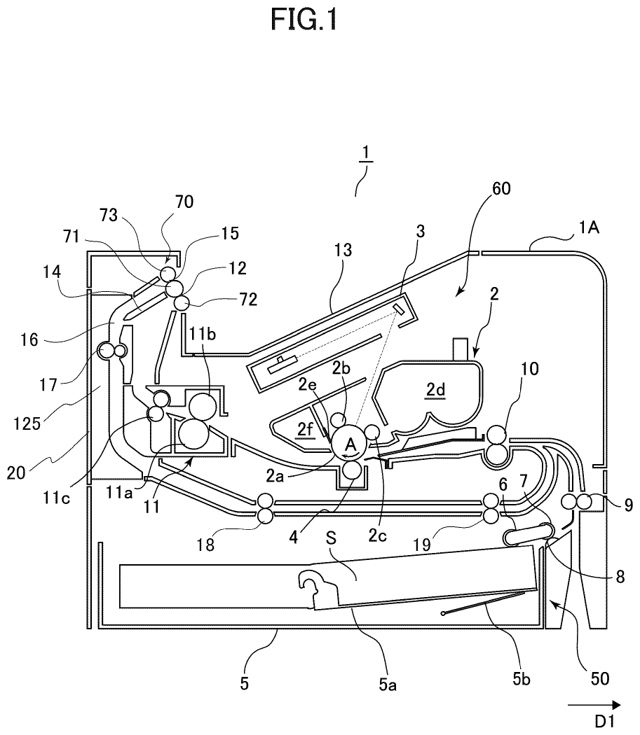

First, a first embodiment of the present disclosure will be described. A printer 1 that serves as an image forming apparatus is an electrophotographic laser-beam printer that forms monochrome toner images. As illustrated in FIG. 1, the printer 1 includes a sheet feeding portion 50 that feeds a sheet stacked, and an image forming portion 60 that forms an image on the sheet fed by the sheet feeding portion 50. In addition, the printer 1 includes a fixing apparatus 11 that serves as a fixing unit that fixes an image transferred to the sheet, to the sheet, and a discharging portion 70 that can discharge the sheet to a discharging tray 13. Note that the sheet may be a paper sheet, such as a sheet for any purpose or an envelope, a plastic film such as an overhead projector (OHP) sheet, or a cloth sheet.

If an image forming command is sent to the printer 1, the image forming portion 60 starts an image forming process in accordance with the image information sent from, for example, an external computer connected to the printer 1. The image forming portion 60 includes a process cartridge 2, a laser scanner 3, and a transfer roller 4. The process cartridge 2 includes a photosensitive drum 2a that rotates in a direction indicated by an arrow A, a charging roller 2b, a developing roller 2c, a cleaning blade 2e, a toner container 2d, and a waste-toner container 2f. The charging roller 2b, the developing roller 2c, and the cleaning blade 2e are disposed along the photosensitive drum 2a. The process cartridge 2 can be attached to and detached from an apparatus body 1A of the printer 1.

The laser scanner 3 emits a laser beam toward the photosensitive drum 2a in accordance with the image information sent from the external computer or the like. In this case, the photosensitive drum 2a is charged in advance by the charging roller 2b. Thus, if the photosensitive drum 2a is irradiated with the laser beam, an electrostatic latent image is formed on the photosensitive drum 2a. The electrostatic latent image is then developed by the developing roller 2c, so that a monochrome toner image is formed on the photosensitive drum 2a.

In parallel with the above-described image forming process, a sheet S is fed from the sheet feeding portion 50. The sheet feeding portion 50 includes a cassette 5 supported by the apparatus body 1A such that the cassette 5 can be attached to and drawn from the apparatus body 1A in a direction orthogonal to the feeding direction of the sheet S. The cassette 5 supports a sheet supporting plate 5a such that the sheet supporting plate 5a that supports the sheet S can be lifted and lowered. The sheet supporting plate 5a is lifted and lowered by a lifting plate 5b being pivoted (driven) by a driving source (not illustrated). The sheet S supported by the sheet supporting plate 5a is fed by a pickup roller 6. The sheet S fed by the pickup roller 6 is separated from other sheets, one by one, by a feed roller 7 and a separation roller 8 that is in pressure contact with the feed roller 7.

The separation roller 8 includes a torque limiter. The limit value of the torque limiter is set so that the separation roller 8 is rotated by the rotation of the feed roller 7 when a single sheet is conveyed to a separation nip formed by the feed roller 7 and the separation roller 8. If a plurality of sheets is conveyed to the separation nip, the separation roller 8 is not rotated by the rotation of the feed roller 7, and stops. Note that driving force may be applied to the separation roller 8 for conveying sheets in a direction opposite to the sheet conveyance direction of the feed roller 7. In addition, although the single cassette 5 is disposed in the present embodiment, a plurality of cassettes that can support different sizes of sheets may be disposed. In this case, a sheet having a selected sheet size may be fed from a corresponding one of the plurality of cassettes.

The sheet S separated, one by one, by the feed roller 7 and the separation roller 8 is conveyed to a registration roller pair 10 by a conveyance roller pair 9, and the skew of the sheet S is corrected by the registration roller pair 10. The sheet S is then conveyed by the registration roller pair 10 at a predetermined conveyance timing, and a toner image formed on the photosensitive drum 2a is transferred to the sheet S by an electrostatic load bias applied to the transfer roller 4. The remaining toner left on the photosensitive drum 2a is collected in the waste-toner container 2f, by the cleaning blade 2e.

The sheet S to which the toner image has been transferred is then applied with predetermined heat and pressure by a heating roller 11b and a pressing roller 11a of the fixing apparatus 11, so that the toner is melted and solidified (fixed). Then the sheet S passes through the fixing apparatus 11, and is discharged to the discharging portion 70 by a conveyance roller pair 11c. The discharging portion 70 is a triple roller constituted by three rollers, and includes a driving roller 71, a first driven roller 72, and a second driven roller 73. The driving roller 71 is driven by a driving source (not illustrated). The first driven roller 72 and the second driven roller 73 are rotated by the rotation of the driving roller 71. The driving roller 71 and the first driven roller 72 form a first nip 12, and the driving roller 71 and the second driven roller 73 form a second nip 15. The sheet S conveyed by the conveyance roller pair 11c is discharged to the discharging tray 13 by the first nip 12.

In a case where images are formed on both sides of the sheet S, the sheet S conveyed by the conveyance roller pair 11c is guided to the second nip 15 by a guiding member 14 that can pivot. Then the sheet S is conveyed toward the outside of the apparatus body 1A by the second nip 15. If the trailing edge of the sheet S has passed through the guiding member 14, the driving roller 71 rotates in a backward direction. With this operation, the sheet S is guided toward the interior of the apparatus body 1A by the second nip 15, and is guided to a duplex conveyance path 16 by the guiding member 14.

The sheet S guided to the duplex conveyance path 16 is conveyed to the registration roller pair 10 by conveyance roller pairs 17, 18, and 19. Then, as in a case where an image is formed on a first side of the sheet S, an image is formed also on a second side of the sheet S opposite to the first side, by the image forming portion 60 and the fixing apparatus 11. The sheet S having images formed on both sides of the sheet S is discharged to the discharging tray 13 by the first nip 12 of the discharging portion 70.

### Configuration of Surroundings of Back Door

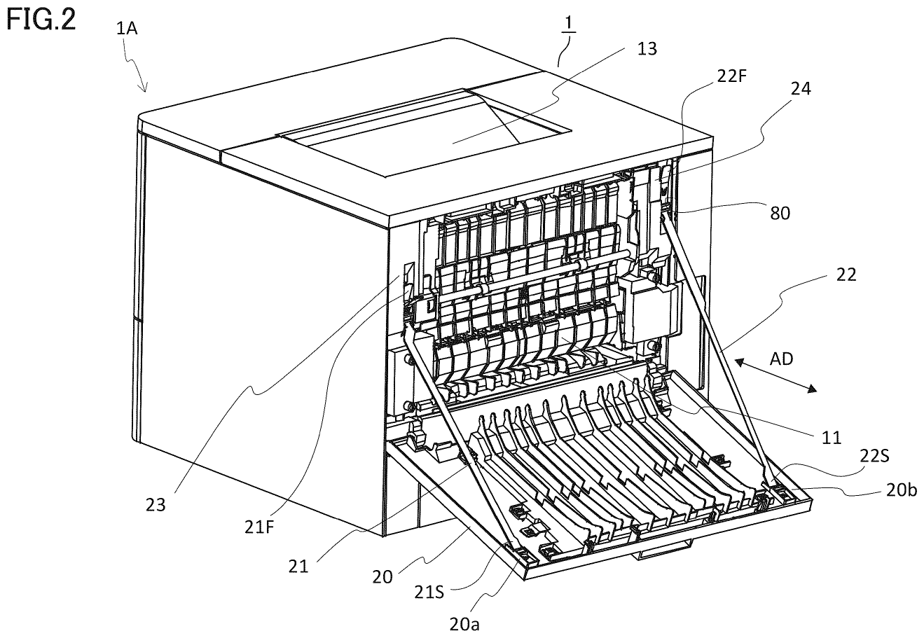

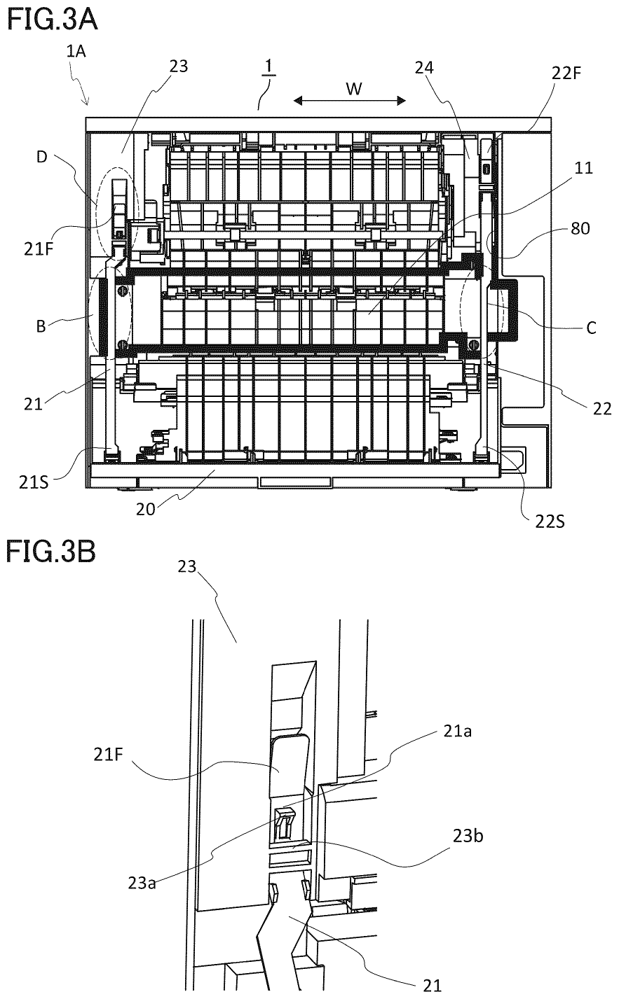

Next, a configuration of surroundings of a back door 20 will be described with reference to FIGS. 1 to 3B. FIG. 2 is a perspective view illustrating the printer 1 in a state where the back door 20 is opened. FIG. 3A is a back view illustrating the interior of the printer 1 in a state where the back door 20 is opened. FIG. 3B is an enlarged perspective view illustrating a broken-line portion D of FIG. 3A. In FIG. 3A, an outline of the fixing apparatus 11 is illustrated with a thick line for convenience of description so that the area occupied by the fixing apparatus 11 can be easily distinguished.

As illustrated in FIGS. 1 and 2, the printer 1 includes the back door 20 supported by the apparatus body 1A such that the back door 20 can be opened and closed (pivoted). The back door 20 that serves as a door is disposed on an upstream end side of the printer 1 in a drawing direction D1 of the cassette 5, and forms a portion of the exterior of the printer 1. That is, if the side on which the cassette 5 is drawn out is defined as the front side of the printer 1, the back door 20 is disposed on the back side of the printer 1 opposite to the front side.

As illustrated in FIG. 2, the apparatus body 1A includes an opening portion 80. The back door 20 can move between a closed position (illustrated in FIG. 1) at which the back door 20 closes the opening portion 80, and an open position (illustrated in FIG. 2) at which the back door 20 opens the opening portion 80.

In addition, the apparatus body 1A and the back door 20 are connected with each other via a single pair of holding members 21 and 22. More specifically, the holding member 21 includes first end portion 21F connected to the apparatus body 1A, and second end portion 21S connected to the back door 20. Similarly, the holding member 22 includes first end portion 22F connected to the apparatus body 1A, and second end portion 22S connected to the back door 20. In other words, the holding members 21 and 22 are connected to the back door 20 so as to move together with the back door 20.

In the present embodiment, each of the holding members 21 and 22 is constituted by a flat band made of polypropylene resin, and has flexibility. That is, in a case where the back door 20 is positioned at the closed position, each of the holding members 21 and 22 is bent, and accommodated in the apparatus body 1A. On the other hand, in a case where the back door 20 is positioned at the open position, each of the holding members 21 and 22 extends in a straight line, as illustrated in FIG. 2, toward the outside of the apparatus body 1A; and holds the back door 20 at the open position. In other words, the holding members 21 and 22 regulate the opening angle of the back door 20.

Note that the configuration of the holding members 21 and 22 is not limited to the above-described configuration. For example, each of the holding members 21 and 22 may be constituted by a wire member, such as a wire. In addition, each of the holding members 21 and 22 may be constituted by a member that includes a damper that reduces the impact caused when the back door 20 is opened. Furthermore, each of the holding members 21 and 22 may be constituted by an arm that slides along the back door 20 when the back door 20 is opened and closed. That is, each of the holding members 21 and 22 may not be bent when the back door 20 is opened and closed.

As illustrated in FIGS. 2 and 3A, the apparatus body 1A of the printer 1 includes casings 23 and 24. The casing 23 is disposed on one end side of the printer 1 in a width direction W orthogonal to the sheet conveyance direction, and the casing 24 is disposed on the other end side of the printer 1. The first end portion 21F of the holding member 21 is connected to the casing 23, and the first end portion 22F of the holding member 22 is connected to the casing 24.

The fixing apparatus 11 that serves as an detachable unit is attached to and detached from the apparatus body 1A via the opening portion 80. However, as illustrated in FIG. 3A, first end portion (i.e., a broken-line portion B) of the fixing apparatus 11 in the width direction W overlaps with the holding member 21, and second end portion (i.e., a broken-line portion C) of the fixing apparatus 11 in the width direction W overlaps with the holding member 22. Note that the fixing apparatus 11 is attached to and detached from the apparatus body 1A in an attachment-and-detachment direction AD illustrated in FIG. 2 and substantially parallel with the horizontal direction. In addition, the trajectory in which the fixing apparatus 11 is attached to and detached from the apparatus body 1A in the attachment-and-detachment direction AD is referred to as an attachment-and-detachment trajectory. In this case, as illustrated in FIG. 3A, when viewed in the attachment-and-detachment direction AD, the holding members 21 and 22 overlap with the attachment-and-detachment trajectory of the fixing apparatus 11. The attachment-and-detachment trajectory of the fixing apparatus 11 is a space in which the area surrounded by the thick line of FIG. 3A extends in a sheet surface direction.

In such a state, if the fixing apparatus 11 is attached to and detached from the apparatus body 1A, the fixing apparatus 11 will interfere with the holding members 21 and 22. That is, the holding members 21 and 22 function as a restricting member that restricts the replacement of the fixing apparatus 11. On the other hand, if the holding members 21 and 22 are disposed in this manner so as to overlap with the attachment-and-detachment trajectory of the fixing apparatus 11, the printer 1 can be downsized in the width direction W.

### Attachment-and-Detachment Method of Fixing Apparatus

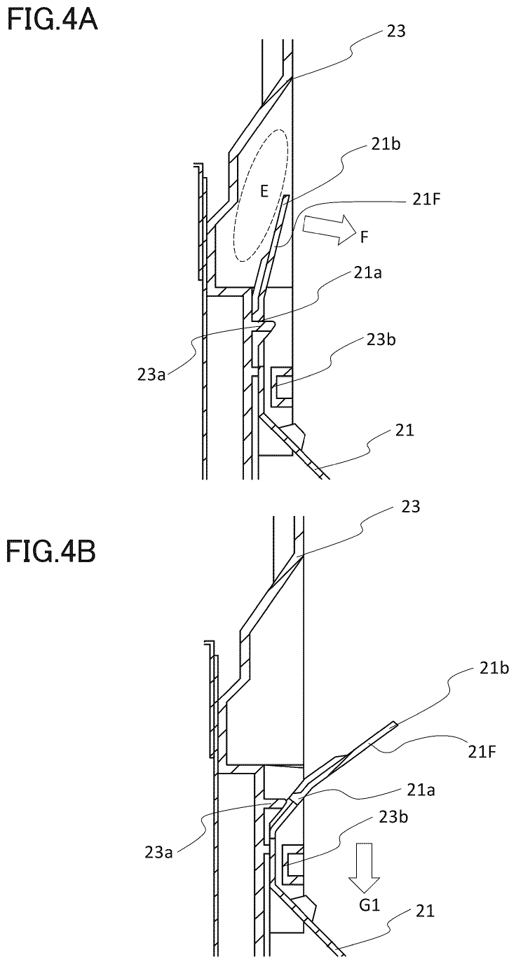

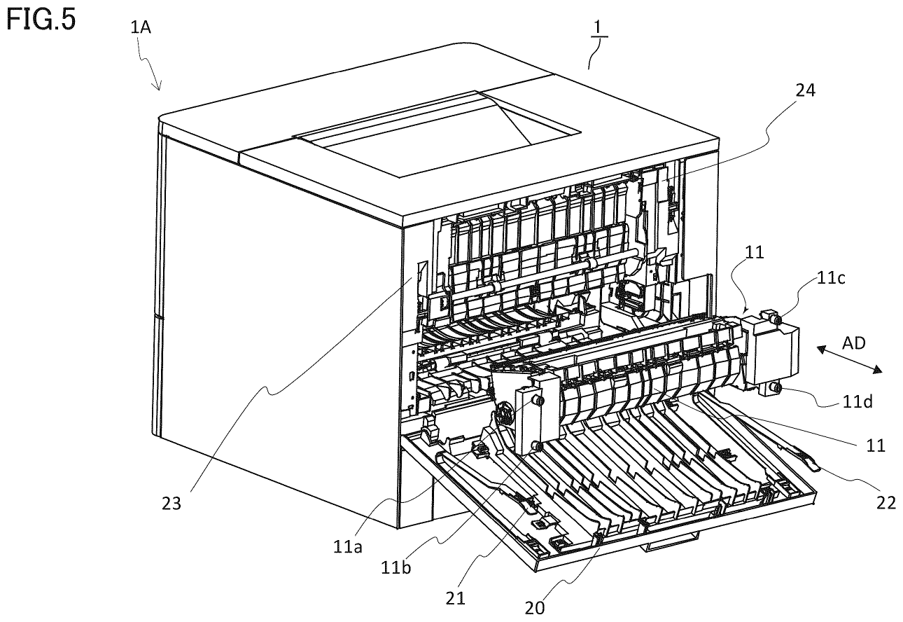

Next, an attachment-and-detachment method of the fixing apparatus 11 will be described with reference to FIGS. 3A to 5. FIG. 4A is a cross-sectional view illustrating a configuration of surroundings of the first end portion 21F of the holding member 21. FIG. 4B is a cross-sectional view illustrating a state where the first end portion 21F of the holding member 21 is being disconnected. FIG. 5 is a perspective view illustrating a state where the fixing apparatus 11 is being detached from the apparatus body 1A.

As illustrated in FIGS. 3B and 4A, the casing 23 of the apparatus body 1A includes a claw portion 23a and a restricting wall 23b, and the first end portion 21F of the holding member 21 includes a hole portion 21a. The restricting wall 23b restricts the first end portion 21F of the holding member 21 from floating up from the casing 23 toward a front side. The holding member 21 is connected to the casing 23 (the apparatus body 1A) by the hole portion 21a of the first end portion 21F engaging with the claw portion 23a.

As illustrated in FIG. 4A, a space E is formed between the holding member 21 and the casing 23, and a worker can put a finger in the space E. Thus, the worker can deform the first end portion 21F in a direction indicated by an arrow F, by putting a finger in the space E and pulling an end portion 21b of the first end portion 21F of the holding member 21 toward the front side. Since the first end portion 21F is deformed in the direction indicated by the arrow F, the hole portion 21a and the claw portion 23a are disengaged from each other, as illustrated in FIG. 4B.

After that, the worker moves the holding member 21 in a direction indicated by an arrow G1 and extending in the gravity direction, so that the holding member 21 passes through a space inside the restricting wall 23b. With this operation, the holding member 21 and the casing 23 are separated from each other, and the holding member 21 and the casing 23 (the apparatus body 1A) are disconnected from each other.

The above-described configuration for connecting the first end portion 21F of the holding member 21 and the casing 23 with each other, and for disconnecting the first end portion 21F of the holding member 21 and the casing 23 from each other is the same as the configuration for connecting the first end portion 22F of the holding member 22 and the casing 24 with each other, and for disconnecting the first end portion 22F of the holding member 22 and the casing 24 from each other. In addition, when the fixing apparatus 11 is attached to and detached from the apparatus body 1A, the holding member 22 and the casing 24 (the apparatus body 1A) are also disconnected from each other.

With the above-described operation, the state of the first end portion 21F of the holding member 21 and the first end portion 22F of the holding member 22 is set to a state where the first end portion 21F and the first end portion 22F can be moved. Thus, as illustrated in FIG. 5, the holding members 21 and 22 can be moved to positions at which the holding members 21 and 22 do not overlap with the attachment-and-detachment trajectory of the fixing apparatus 11. That is, in a state where the back door 20 is positioned at the open position, the holding members 21 and 22 can move from a first position (illustrated in FIG. 2) at which the holding members 21 and 22 overlap with the attachment-and-detachment trajectory of the fixing apparatus 11, to a second position (illustrated in FIG. 5) at which the holding members 21 and 22 do not overlap with the attachment-and-detachment trajectory of the fixing apparatus 11. In addition, the holding members 21 and 22 can be moved from the first position to the second position by the first end portion 21F and the first end portion 22F being disconnected from the apparatus body 1A. In addition, at the second position, the holding members 21 and 22 allow the fixing apparatus 11 to be attached to and detached from the apparatus body 1A.

As illustrated in FIG. 5, the fixing apparatus 11 is fixed to the apparatus body 1A via screws 11a, 11b, 11c, and 11d. The screws 11a, 11b, 11c, and 11d are fastening members that can detach from the fixing apparatus 11 without using any tool, and may be knob bolts. After removing or loosening the four screws 11a, 11b, 11c, and 11d, a worker can detach the fixing apparatus 11 in a detaching direction parallel to the attachment-and-detachment direction AD (see FIG. 2). Note that in the present embodiment, the screws 11a to 11d are not separated from the fixing apparatus 11 for preventing the screws 11a to 11d from being lost. The work for attaching the fixing apparatus 11 to the apparatus body 1A may be performed in the reverse order to the above-described work for detaching the fixing apparatus 11 from the apparatus body 1A.

As described above, the holding members 21 and 22 of the present embodiment can move from the first position (illustrated in FIG. 2) to the second position (illustrated in FIG. 5) at which the holding members 21 and 22 do not overlap with the attachment-and-detachment trajectory of the fixing apparatus 11. Since the holding members 21 and 22 overlap with the attachment-and-detachment trajectory of the fixing apparatus 11 at the first position, the printer 1 can be downsized in the width direction W. In addition, the holding members 21 and 22 can be moved to the second position by disconnecting the first end portion 21F and the first end portion 22F from the apparatus body 1A. In this state, the fixing apparatus 11 can be attached to and detached from the apparatus body 1A. Thus, the workability for attaching and detaching the fixing apparatus 11 can be kept good.

In addition, each of the first end portion 21F of the holding member 21 and the first end portion 22F of the holding member 22 can be easily disconnected from the apparatus body 1A by simply disengaging the claw portion 23a and the hole portion 21a from each other. Thus, the workability for attaching and detaching the fixing apparatus 11 can be improved. In addition, each of the holding members 21 and 22 is constituted by a flexible band. Thus, in a case where the back door 20 is positioned at the closed position, the holding members 21 and 22 are bent, so that the space occupied by the holding members 21 and 22 is made smaller. As a result, the printer 1 can be downsized and reduced in cost.

### Modifications of First Embodiment

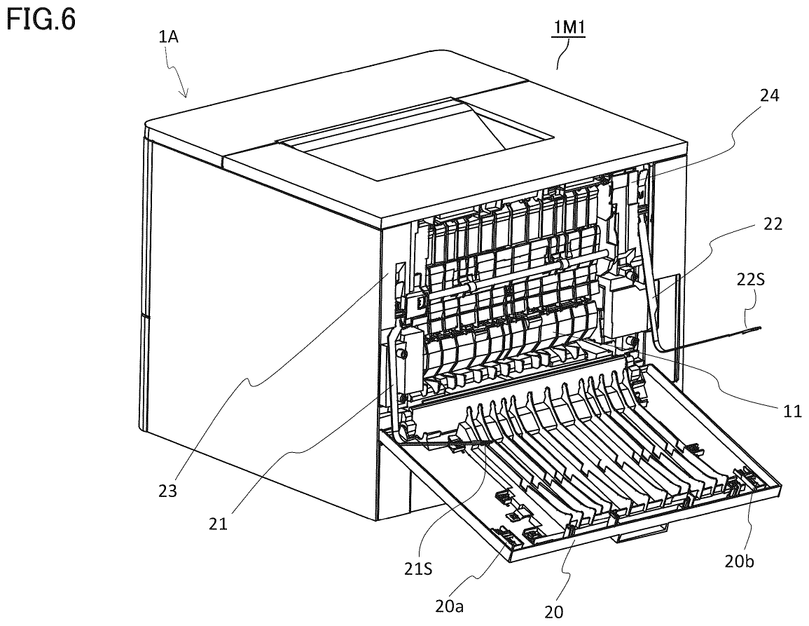

Next, modifications of the first embodiment will be described with reference to FIGS. 6 to 11B. FIG. 6 is a perspective view illustrating a printer 1M1 of a first modification of the first embodiment. In the above-described first embodiment, the description has been made for the configuration in which the holding members 21 and 22 are moved to the second position by disconnecting each of the first end portion 21F of the holding member 21 and the first end portion 22F of the holding member 22 from the apparatus body 1A. However, the present disclosure is not limited to this.

For example, as illustrated in FIG. 6, the holding members 21 and 22 may be moved to the second position at which the holding members 21 and 22 do not overlap with the attachment-and-detachment trajectory of the fixing apparatus 11, by disconnecting the second end portion 21S of the holding member 21 and the second end portion 22S of the holding member 22 from the back door 20. For example, claw portions 20a and 20b may be disposed on the back door 20, and hole portions that can engage with the claw portions 20a and 20b may respectively be disposed in the second end portions 21S and 22S of the holding members 21 and 22. In this case, the holding members 21 and 22 and the back door 20 are connected with each other by the claw portions 20a and 20b and the hole portions engaging with each other, and are disconnected from each other by the claw portions 20a and 20b and the hole portions separating from each other.

Note that the first end portion 21F of the holding member 21 and the first end portion 22F of the holding member 22 may be connected to and disconnected from the apparatus body 1A as in the first embodiment, and the second end portion 21S of the holding member 21 and the second end portion 22S of the holding member 22 may be connected to and disconnected from the back door 20. In this case, the fixing apparatus 11 may be attached to and detached from the apparatus body 1A by a worker disconnecting at least one of the first end portion 21F and the second end portion 21S of the holding member 21 and at least one of the first end portion 22F and the second end portion 22S of the holding member 22.

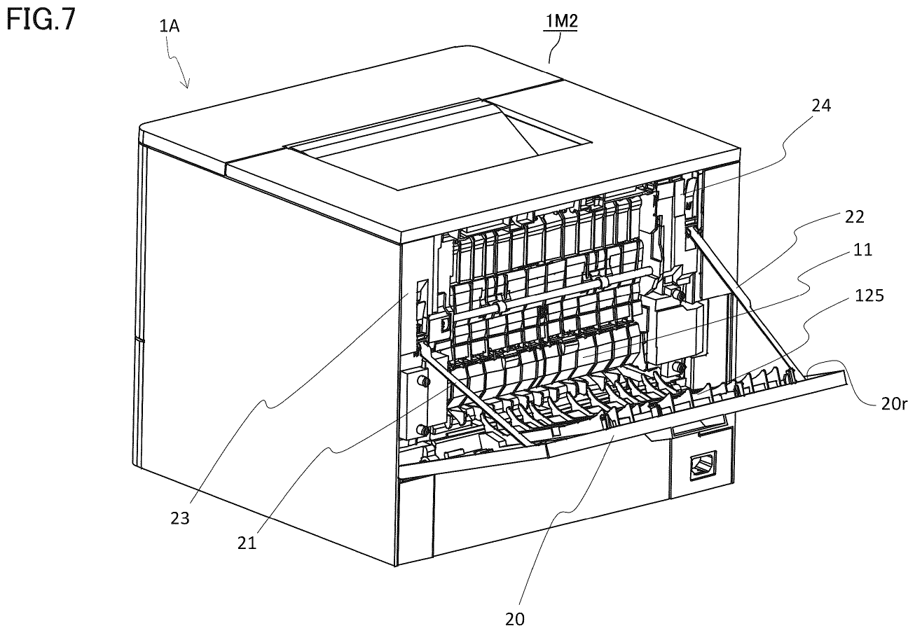

FIG. 7 is a perspective view illustrating a printer 1M2 of a second modification of the first embodiment. In the printer 1M2 illustrated in FIG. 7, the opening angle of the back door 20 is set smaller than that of the back door 20 of the printer 1 of the first embodiment. The opening angle is set, for reducing the sound and impact produced when the back door 20 is opened, for example. In this case, in a state where the back door 20 is opened, not only the holding members 21 and 22 but also the back door 20 and a guide member 125 fixed to a back surface 20r (see FIG. 7) of the back door 20 overlap with the attachment-and-detachment trajectory of the fixing apparatus 11. Also in this case, the fixing apparatus 11 can be attached to and detached from the apparatus body 1A by disconnecting the holding members 21 and 22 from at least one of the apparatus body 1A and the back door 20.

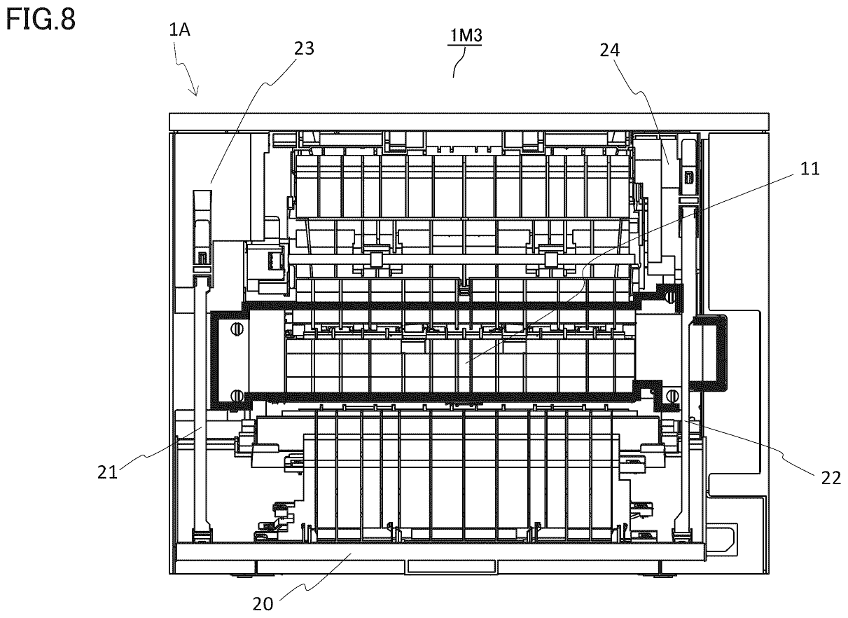

FIG. 8 is a back view illustrating a printer 1M3 of a third modification of the first embodiment. In the first embodiment, both of the holding members 21 and 22 positioned at the first position overlap with the attachment-and-detachment trajectory of the fixing apparatus 11. However, the present disclosure is not limited to this. For example, as illustrated in FIG. 8, the holding member 21 may be disposed at a position at which the holding member 21 does not overlap with the attachment-and-detachment trajectory of the fixing apparatus 11 in a state where the holding member 21 is connected to both of the casing 23 of the apparatus body 1A and the back door 20. On the other hand, the holding member 22 is disposed, as in the first embodiment, at a position at which the holding member 22 overlaps with the attachment-and-detachment trajectory of the fixing apparatus 11 in a state where the holding member 22 is connected to both of the casing 24 of the apparatus body 1A and the back door 20.

In this case, the fixing apparatus 11 can be attached to and detached from the apparatus body 1A without operating the holding member 21, by disconnecting at least one of the first end portion 22F and the second end portion 22S of the holding member 22.

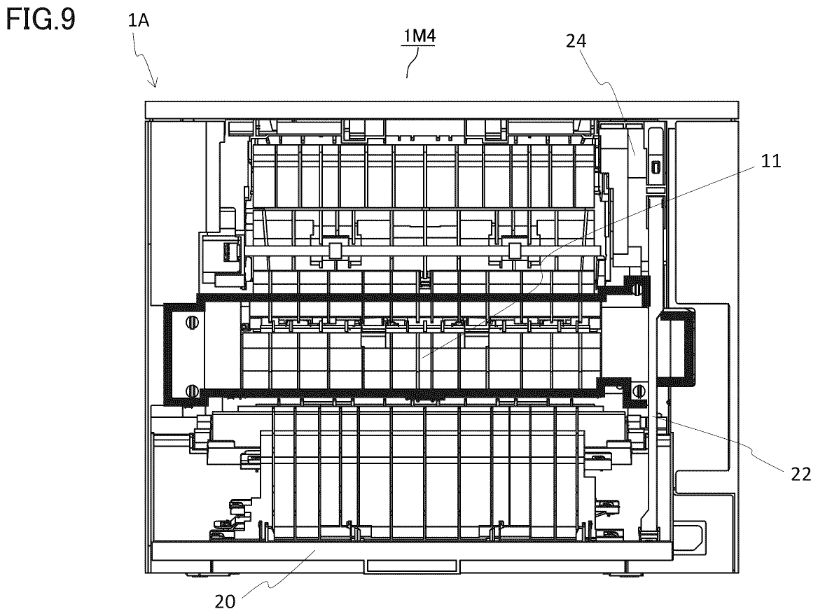

FIG. 9 is a back view illustrating a printer 1M4 of a fourth modification of the first embodiment. In the first embodiment, the back door 20 is held by the single pair of holding members 21 and 22 at the open position. However, the present disclosure is not limited to this. In particular, in a case where the back door 20 is small and light in weight, the back door 20 positioned at the open position may be held by a single holding member (e.g., the holding member 22). In this case, the fixing apparatus 11 can be attached to and detached from the apparatus body 1A by disconnecting at least one of the first end portion 22F and the second end portion 22S of the holding member 22.

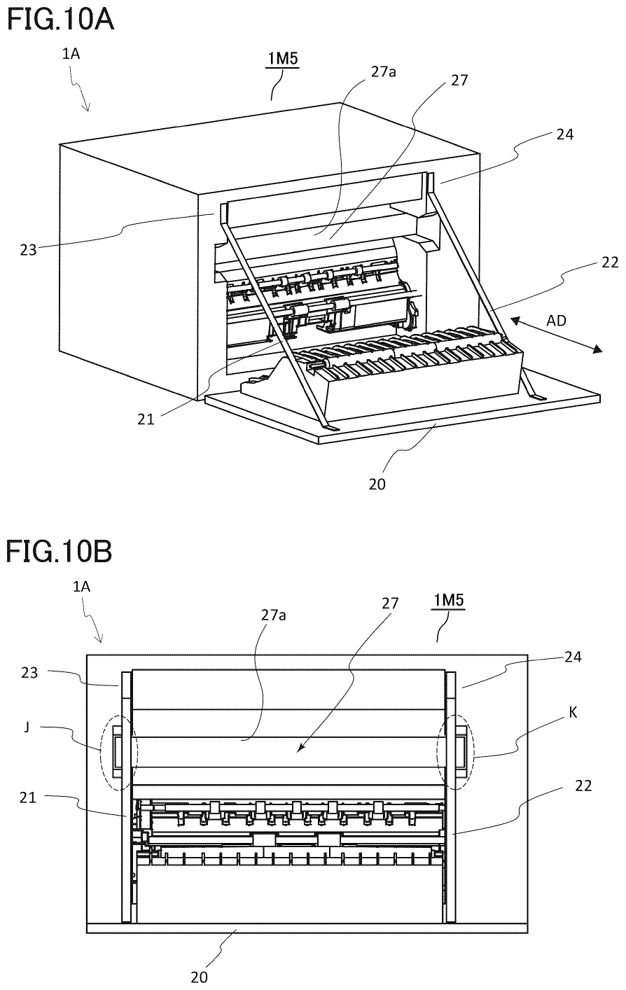

FIG. 10A is a perspective view illustrating a printer 1M5 of a fifth modification of the first embodiment. FIG. 10B is a back view illustrating the printer 1M5. The printer 1 of the first embodiment is a monochrome laser-beam printer. However, the present disclosure is not limited to this. For example, as in the present (fifth) modification, the present disclosure may be applied to an electrophotographic laser-beam printer that forms full-color toner images. In the present modification, the detachable unit (replacement unit) attached to and detached from the apparatus body 1A is a transfer unit 27, for example. The transfer unit 27 includes a transfer belt 27a that bears a toner image transferred from the photosensitive drum and to be transferred to a sheet. Like the above-described fixing apparatus 11, the transfer unit 27 is attached to and detached from the apparatus body 1A in the attachment-and-detachment direction AD substantially parallel with the horizontal direction.

As illustrated in FIGS. 10A and 10B, the holding members 21 and 22 positioned at the first position respectively overlap with the attachment-and-detachment trajectory of the transfer unit 27 in broken-line portions J and K. Thus, the attachment and detachment of the transfer unit 27 is restricted by the holding members 21 and 22. In a case where the transfer unit 27 is attached to and detached from the apparatus body 1A, a worker disconnects at least one of the first end portion 21F and the second end portion 21S of the holding member 21 and at least one of the first end portion 22F and the second end portion 22S of the holding member 22. With this operation, the transfer unit 27 can be attached to and detached from the apparatus body 1A.

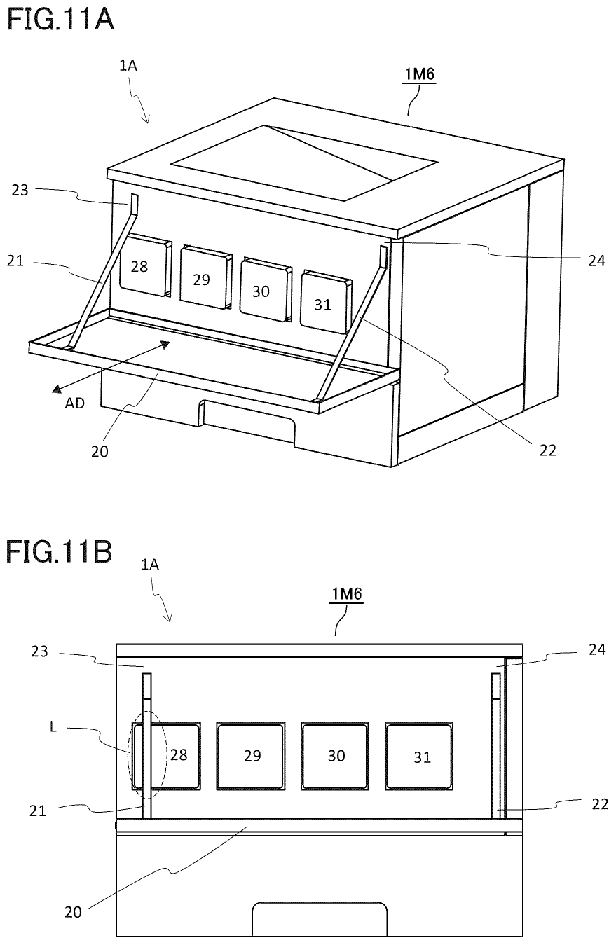

FIG. 11A is a perspective view illustrating a printer 1M6 of a sixth modification of the first embodiment. FIG. 11B is a back view illustrating the printer 1M6. As in the fifth modification, the printer 1M6 is an electrophotographic laser-beam printer that forms full-color toner images. In the present modification, the detachable unit (replacement unit) attached to and detached from the apparatus body 1A is process cartridges 28, 29, 30, and 31, for example. Each of the process cartridges 28, 29, 30, and 31 includes a photosensitive drum that bears an electrostatic latent image, a developing roller that develops the electrostatic latent image into a toner image, and a toner storage portion that stores toner. Like the above-described fixing apparatus 11, the process cartridges 28, 29, 30, and 31 are attached to and detached from the apparatus body 1A in the attachment-and-detachment direction AD substantially parallel with the horizontal direction.

As illustrated in FIGS. 11A and 11B, the holding member 21 positioned at the first position overlaps with the attachment-and-detachment trajectory of the process cartridge 28 in a broken-line portion L. Thus, the attachment and detachment of the process cartridge 28 is restricted by the holding member 21. In a case where the process cartridge 28 is attached to and detached from the apparatus body 1A, a worker disconnects at least one of the first end portion 21F and the second end portion 21S of the holding member 21. With this operation, the process cartridge 28 can be attached to and detached from the apparatus body 1A.

### Second Embodiment

Next, a second embodiment of the present disclosure will be described. In the second embodiment, not the holding members (21, 22) but a guide member 25 fixed to the back door 20 overlaps with the attachment-and-detachment trajectory of the fixing apparatus 11. Thus, the same components as those of the first embodiment are omitted in the drawings, or will be described with the same symbols given to the drawings.

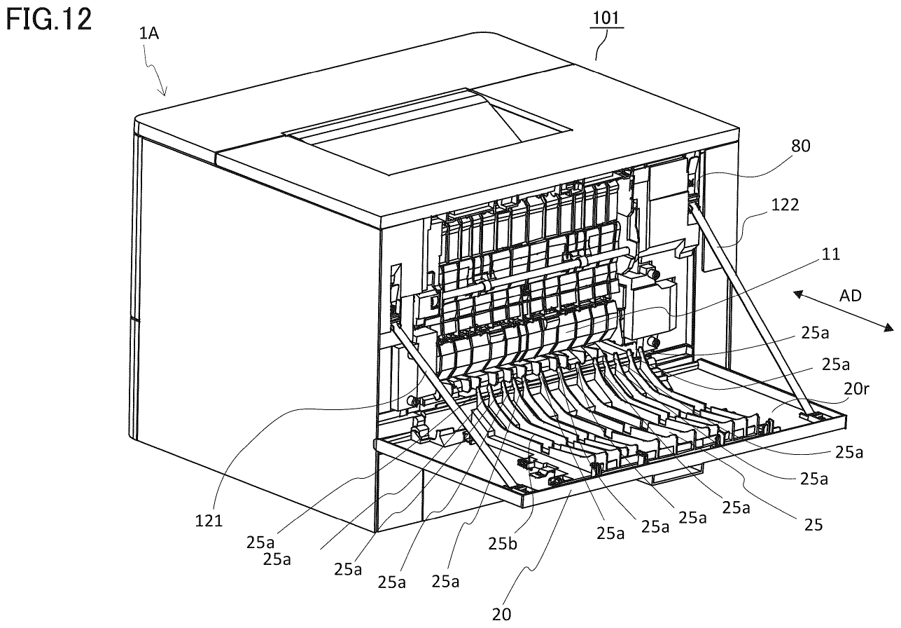

As illustrated in FIG. 12, a printer 101 of the present embodiment includes an apparatus body 1A and a back door 20, which are the same as those of the first embodiment, holding members 121 and 122, and the guide member 25. The guide member 25 that serves as a connected member is connected to the back door 20 so as to move together with the back door 20. That is, the guide member 25 is supported by the back door 20 such that the guide member 25 can be attached to and detached from the back door 20.

### Configuration of Surroundings of Back Door

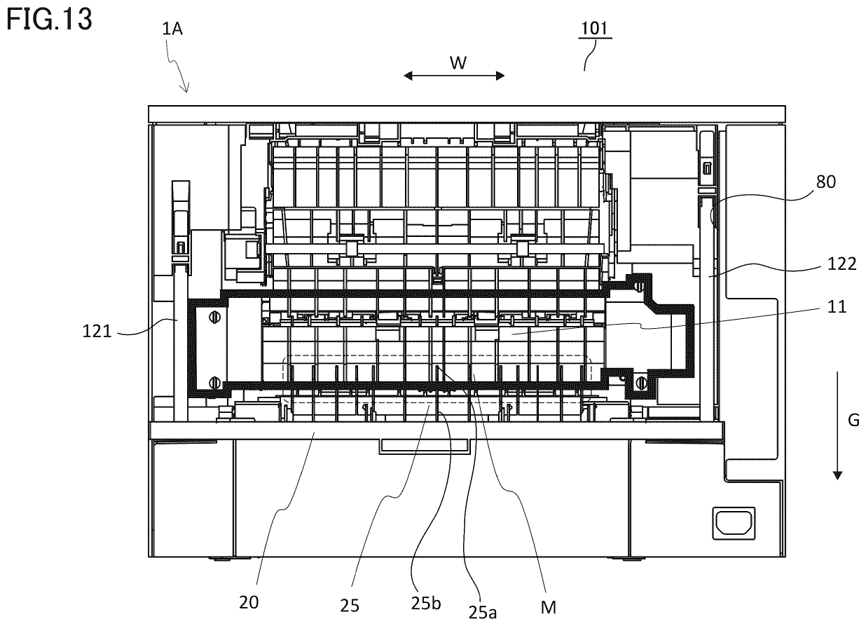

Next, a configuration of surroundings of the back door 20 will be described with reference to FIGS. 12 and 13. FIG. 12 is a perspective view illustrating the printer 101 in a state where the back door 20 is opened. FIG. 13 is a back view illustrating the interior of the printer 101 in a state where the back door 20 is opened. In FIG. 13, an outline of the fixing apparatus 11 is illustrated with a thick line for convenience of description so that the area occupied by the fixing apparatus 11 can be easily distinguished.

As illustrated in FIG. 12, the apparatus body 1A and the back door 20 are connected with each other via a single pair of holding members 121 and 122. The single pair of holding members 121 and 122 holds the back door 20 positioned at the open position. As illustrated in FIG. 13, the holding members 121 and 122 of the present embodiment are disposed outside the attachment-and-detachment trajectory of the fixing apparatus 11 in the width direction W. That is, the holding members 121 and 122 are disposed so as not to overlap with the attachment-and-detachment trajectory of the fixing apparatus 11.

As illustrated in FIGS. 12 and 13, the back door 20 includes a back surface 20r that serves as a surface that faces the apparatus body 1A in a case where the back door 20 is positioned at the closed position, and the guide member 25 is connected to the back surface 20r. The guide member 25 includes a plurality of conveyance ribs 25b that extends along the sheet conveyance direction. The plurality of conveyance ribs 25b forms the duplex conveyance path 16 (see FIG. 1) in a case where the back door 20 is positioned at the closed position. That is, in a case where the back door 20 is positioned at the closed position, the guide member 25 guides the sheet S that passes through the duplex conveyance path 16. The downstream ends of the plurality of conveyance ribs 25b in the sheet conveyance direction form rib ends 25a that project upward in a case where the back door 20 is positioned at the open position.

The fixing apparatus 11 is attached to and detached from the apparatus body 1A via the opening portion 80. However, as illustrated in FIG. 13, in a lower edge portion (i.e., a broken-line portion M) of the fixing apparatus 11, the fixing apparatus 11 overlaps with the rib ends 25a of the conveyance ribs 25b of the guide member 25 in a gravity direction G. That is, as illustrated in FIG. 13, when viewed in the attachment-and-detachment direction AD of the fixing apparatus 11, at least a portion of the guide member 25 overlaps with the attachment-and-detachment trajectory of the fixing apparatus 11. The attachment-and-detachment trajectory of the fixing apparatus 11 is a space in which the area surrounded by the thick line of FIG. 13 extends in a sheet surface direction.

In such a state, if the fixing apparatus 11 is attached to and detached from the apparatus body 1A, the fixing apparatus 11 will interfere with the guide member 25. That is, the guide member 25 functions as a restricting member that restricts the replacement of the fixing apparatus 11. On the other hand, if the guide member 25 is disposed in this manner so as to overlap with the attachment-and-detachment trajectory of the fixing apparatus 11, the printer 101 can be downsized in the gravity direction G.

### Attachment-and-Detachment Method of Fixing Apparatus

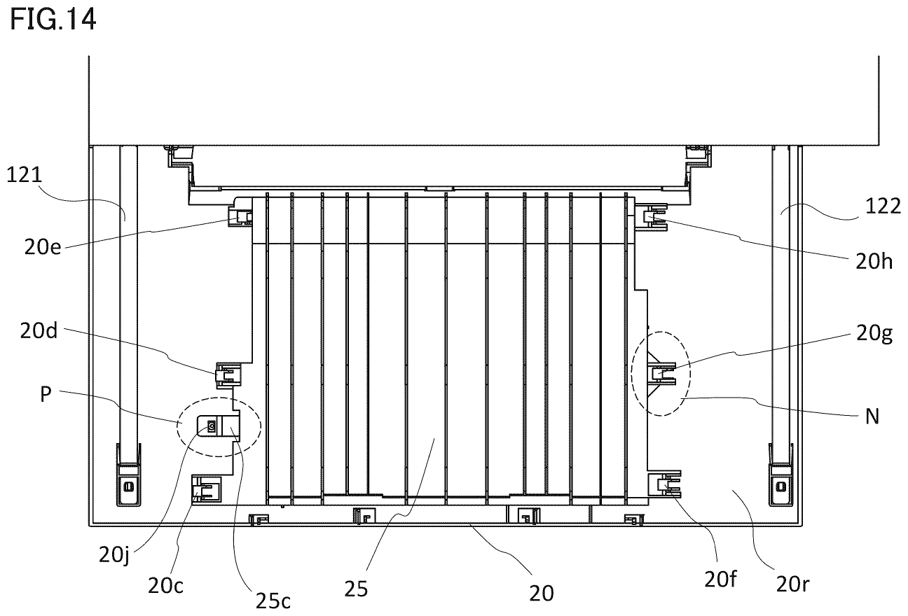

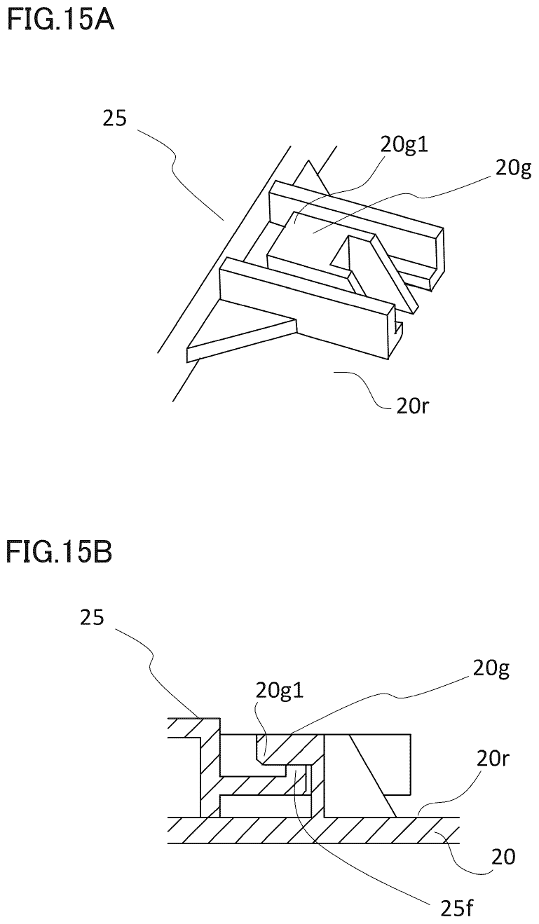

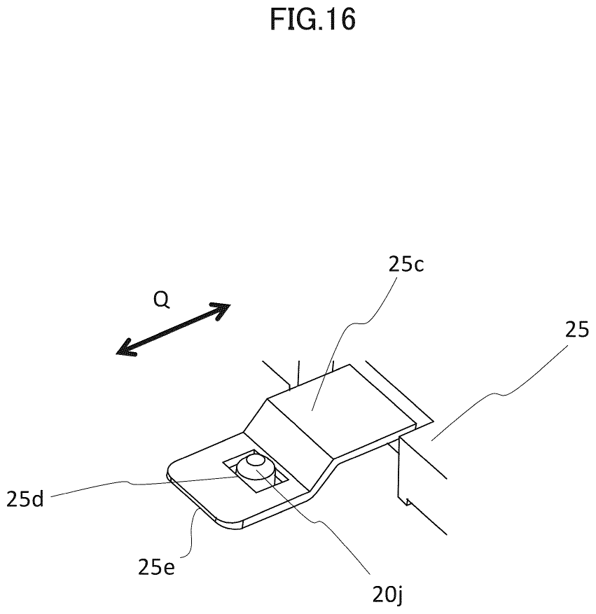

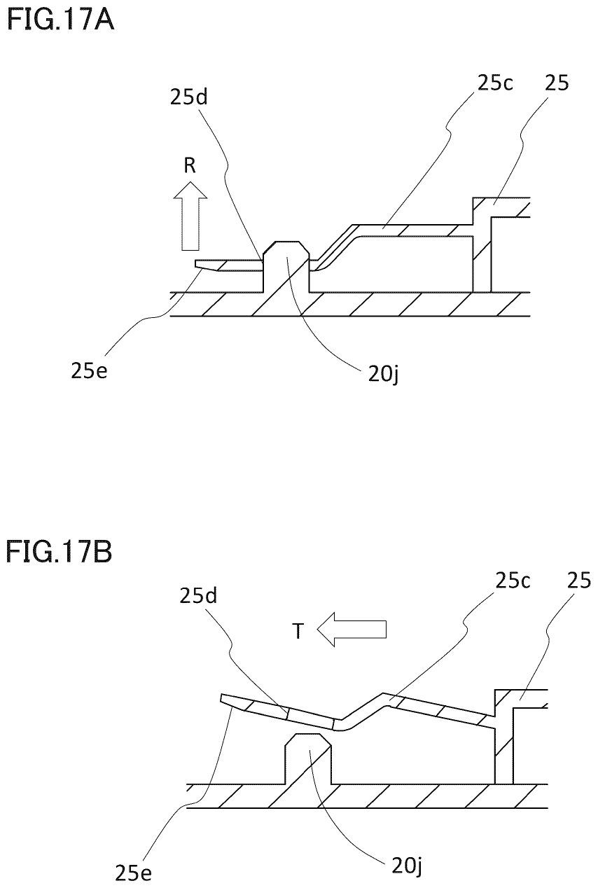

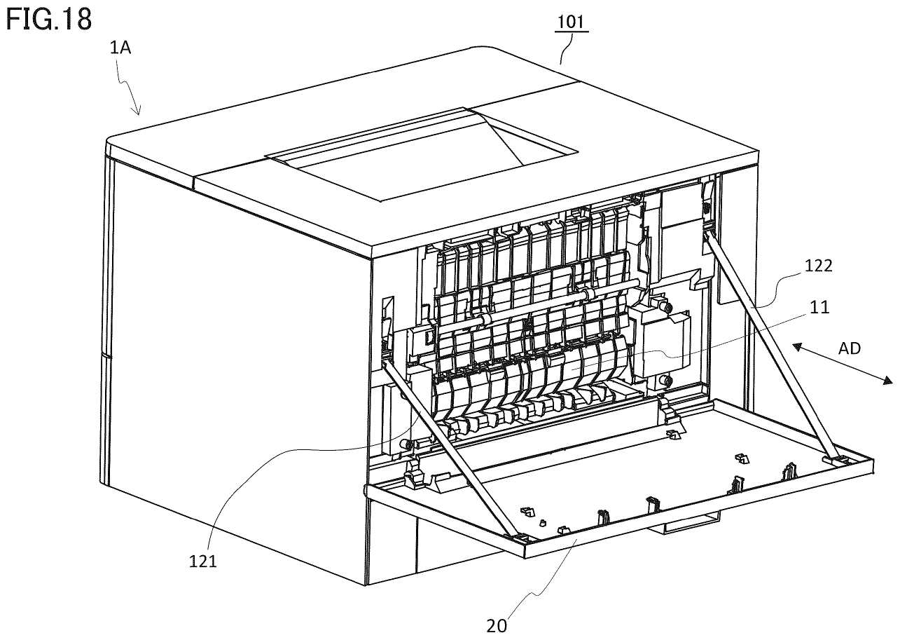

Next, an attachment-and-detachment method of the fixing apparatus 11 will be described with reference to FIGS. 14 to 18. FIG. 14 is a plan view illustrating the guide member 25 and the back door 20. FIG. 15A is an enlarged perspective view illustrating a broken-line portion N of FIG. 14. FIG. 15B is a cross-sectional view of the broken-line portion N of FIG. 14. FIG. 16 is an enlarged perspective view illustrating a broken-line portion P of FIG. 14. FIG. 17A is a cross-sectional view illustrating a state where a tab 25c of the guide member 25 fits in a boss 20j of the back door 20. FIG. 17B is a cross-sectional view illustrating a state where the tab 25c of the guide member 25 is being separated from the boss 20j of the back door 20. FIG. 18 is a perspective view illustrating a state where the guide member 25 is detached from the back door 20.

As illustrated in FIG. 14, the guide member 25 is engaged with hook portions 20c, 20d, 20e, 20f, 20g, and 20h disposed in the back surface 20r of the back door 20. Since each of the hook portions 20c, 20d, 20e, 20f, 20g, and 20h is engaged with the guide member 25 in the same configuration as that in which the others are engaged with the guide member 25, only the configuration in which the hook portion 20g is engaged with the guide member 25 will be described with reference to FIGS. 15A and 15B.

As illustrated in FIGS. 15A and 15B, the hook portion 20g projects from the back surface 20r of the back door 20. The hook portion 20g includes an engaging portion 20g1 that extends along the back surface 20r. The guide member 25 includes an engaged portion 25f that is inserted between the engaging portion 20g1 of the hook portion 20g and the back surface 20r and engaged with the engaging portion 20g1.

In addition, as illustrated in FIG. 14, the back door 20 includes the boss 20j disposed between the hook portion 20c and the hook portion 20d. The boss 20j projects upward from the back surface 20r in a case where the back door 20 is positioned at the open position. The guide member 25 includes the tab 25c disposed at a position corresponding to the position of the boss 20j.

As illustrated in FIG. 16, the tab 25c includes a fitting hole 25d, and the boss 20j of the back door 20 fits in the fitting hole 25d. Thus, the guide member 25 is positioned with respect to the back door 20 in a direction indicated by an arrow Q.

As illustrated in FIG. 17A, a worker can deform the tab 25c in a direction indicated by an arrow R, by putting a finger on an end 25e of the tab 25c and pulling the end 25e toward a front side. Since the tab 25c is deformed in the direction indicated by the arrow R, the fitting hole 25d and the boss 20j are disengaged from each other, as illustrated in FIG. 17B. That is, the tab 25c and the boss 20j constitute a so-called snap-fit which can connect/disconnect the back door 20 and the guide member 25 with/from each other without using any tool.

After that, the worker moves the guide member 25 in a direction indicated by an arrow T, and thereby detaches the guide member 25 from the hook portions 20c, 20d, 20e, 20f, 20g, and 20h of the back door 20. With this operation, the guide member 25 and the back door 20 are disconnected from each other.

With the above-described operations, the state of the guide member 25 becomes a state where the guide member 25 can move, and the guide member 25 can be moved to a position at which the guide member 25 does not overlap with the attachment-and-detachment trajectory of the fixing apparatus 11. That is, in a state where the back door 20 is positioned at the open position, the guide member 25 can move from a first position (illustrated in FIGS. 12 and 13) at which the guide member 25 overlaps with the attachment-and-detachment trajectory of the fixing apparatus 11, to a second position at which the guide member 25 does not overlap with the attachment-and-detachment trajectory of the fixing apparatus 11. In a state where the guide member 25 is attached to the back door 20 positioned at the open position, at least a portion of the guide member 25 overlaps with the attachment-and-detachment trajectory of the fixing apparatus 11. In addition, at the second position, the guide member 25 allows the fixing apparatus 11 to be attached to and detached from the apparatus body 1A. Note that the second position may be any position as long as the guide member 25 does not overlap with the attachment-and-detachment trajectory of the fixing apparatus 11 at the position. For example, a position at which the guide member 25 is placed apart from the printer 101 after detached from the back door 20 is the second position. In other words, the guide member 25 is retracted from the attachment-and-detachment trajectory of the fixing apparatus 11 by the guide member 25 being detached from the back door 20.

Since the method of detaching the fixing apparatus 11 from the apparatus body 1A is the same as that in the first embodiment, the description thereof will be omitted. The work for attaching the fixing apparatus 11 to the apparatus body 1A may be performed in the reverse order to the above-described work for detaching the fixing apparatus 11 from the apparatus body 1A.

As described above, the guide member 25 of the present embodiment can move from the first position (illustrated in FIGS. 12 and 13) to the second position (e.g., a position to which the guide member 25 is moved after detached from the back door 20) at which the guide member 25 does not overlap with the attachment-and-detachment trajectory of the fixing apparatus 11. Since the guide member 25 overlaps with the attachment-and-detachment trajectory of the fixing apparatus 11 at the first position, the printer 101 can be downsized in the gravity direction G. In addition, the guide member 25 can be moved to the second position by disconnecting the guide member 25 from the back door 20. In this state, the fixing apparatus 11 can be attached to and detached from the apparatus body 1A. Thus, the workability for attaching and detaching the fixing apparatus 11 can be kept good.

In addition, the guide member 25 can be easily disconnected from the back door 20 by only disengaging the boss 20j and the tab 25c, which constitute a snap-fit, from each other and by separating the guide member 25 from the plurality of hook portions 20c to 20h. Thus, the workability for attaching and detaching the fixing apparatus 11 can be improved.

### Other Embodiments

Note that in the above-described embodiments, the description has been made for the case where the detachable unit attached to and detached from the apparatus body 1A is the fixing apparatus 11, the transfer unit 27, or the process cartridges 28 to 31. However, the present disclosure is not limited to this. For example, a toner cartridge that stores toner, a cartridge tray that supports the process cartridges, or the like may be used as the detachable unit.

In addition, in any one of the above-described embodiments, the description has been made for the configuration in which an detachable unit, such as the fixing apparatus 11, is attached to and detached from the apparatus body 1A by opening the back door 20. However, the present disclosure is not limited to this. For example, the detachable unit, such as the fixing apparatus 11, may be attached to and detached from the apparatus body 1A by opening a top cover, instead of the back door 20, disposed in a top surface of the printer 1.

In addition, in the first embodiment, the claw portion 23a is disposed in the casing 23 of the apparatus body 1A, and the hole portion 21a is disposed in the first end portion 21F of the holding member 21. However, the present disclosure is not limited to this. For example, the hole portion 21a may be disposed in the casing 23 of the apparatus body 1A, and the claw portion 23a may be disposed in the first end portion 21F of the holding member 21. That is, the claw portion 23a has only to be disposed in either one of the apparatus body 1A and the first end portion 21F of the holding member 21, and the hole portion 21a has only to be disposed in the other one of the apparatus body 1A and the first end portion 21F of the holding member 21.

Similarly, in the first modification of the first embodiment, the claw portion 20a is disposed in the back door 20, and the hole portion is disposed in the second end portion 21S of the holding member 21. However, the present disclosure is not limited to this. For example, the hole portion may be disposed in the back door 20, and the claw portion 20a may be disposed in the second end portion 21S of the holding member 21. That is, the claw portion 20a has only to be disposed in either one of the back door 20 and the second end portion 21S of the holding member 21, and the hole portion has only to be disposed in the other one of the back door 20 and the second end portion 21S of the holding member 21.

In addition, in any one of the above-described embodiments, the holding members 21 and 22 and the guide member 25 can be moved from the first position to the second position by disconnecting the holding members 21 and 22 and the guide member 25 from at least one of the apparatus body 1A and the back door 20. However, the present disclosure is not limited to this. That is, the holding members 21 and 22 and the guide member 25 may be moved from the first position to the second position even if the holding members 21 and 22 and the guide member 25 are not disconnected from the apparatus body 1A and the back door 20. For example, the holding members 21 and 22 may have flexibility, and may be made longer than the holding members 21 and 22 of the first embodiment. In this case, the holding members 21 and 22 may be retracted from the attachment-and-detachment trajectory of the fixing apparatus 11 by bending the holding members 21 and 22 outward in the width direction W, by slightly lifting the back door 20 from the open position. In addition, the guide member 25 may be supported by the back door 20 such that the guide member 25 can move from a position at which the guide member 25 overlaps with the attachment-and-detachment trajectory of the fixing apparatus 11, to a position at which the guide member 25 does not overlap with the attachment-and-detachment trajectory of the fixing apparatus 11.

In addition, although any one of the above-described embodiments has been described for the case where the electrophotographic printer is used, the present disclosure is not limited to this. For example, the present disclosure may also be applied to an ink-jet image forming apparatus that forms images on sheets by injecting ink from a nozzle.

In addition, part or all of any one of the above-described embodiments and modifications may be freely combined with part or all of another of the above-described embodiments and modifications.

The present disclosure can downsize the apparatus while providing good workability for attaching and detaching the detachable unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-117439, filed Jul. 23, 2024, which is hereby incorporated by reference herein in its entirety.

What is claimed is:

1. An image forming apparatus configured to form an image on a sheet, the image forming apparatus comprising:
an apparatus body including an opening portion;
an detachable unit configured to be attached to and detached from the apparatus body via the opening portion;
a door openably and closably supported by the apparatus body and configured to move between a closed position at which the door closes the opening portion and an open position at which the door opens the opening portion; and
a holding member including a first end portion connected to the apparatus body and a second end portion connected to the door, the holding member being configured to move together with the door and to hold the door positioned at the open position,
wherein the holding member is movable from a first position to a second position in a state where the door is positioned at the open position, the first position being a position at which the holding member overlaps with an attachment-and-detachment trajectory of the detachable unit, the second position being a position at which the holding member does not overlap with the attachment-and-detachment trajectory of the detachable unit and allows the detachable unit to be attached to and detached from the apparatus body.

2. The image forming apparatus according to claim 1, wherein the holding member is movable from the first position to the second position by the first end portion and the apparatus body being disconnected from each other.

3. The image forming apparatus according to claim 2, wherein either one of the apparatus body and the first end portion includes a claw portion,
wherein the other one of the apparatus body and the first end portion includes a hole portion configured to engage with the claw portion, and
wherein the holding member and the apparatus body are configured to be connected with each other by the claw portion and the hole portion engaging with each other, and disconnected from each other by the claw portion and the hole portion separating from each other.

4. The image forming apparatus according to claim 1, wherein the holding member is movable from the first position to the second position by the second end portion and the door being disconnected from each other.

5. The image forming apparatus according to claim 4, wherein either one of the door and the second end portion includes a claw portion,
wherein the other of the door and the second end portion includes a hole portion configured to engage with the claw portion, and
wherein the holding member and the door are configured to be connected with each other by the claw portion and the hole portion engaging with each other, and disconnected from each other by the claw portion and the hole portion separating from each other.

6. The image forming apparatus according to claim 1, wherein the holding member has flexibility, and is bent in a case where the door is positioned at the closed position.

7. The image forming apparatus according to claim 1, further comprising a guide member detachably supported by the door and configured to guide a sheet in a case where the door is positioned at the closed position.

8. The image forming apparatus according to claim 7, wherein at least a portion of the guide member is configured to overlap with the attachment-and-detachment trajectory of the detachable unit in a state where the guide member is attached to the door positioned at the open position, and
wherein the guide member is configured to be retracted from the attachment-and-detachment trajectory by being detached from the door.

9. The image forming apparatus according to claim 1, wherein the door forms a portion of an exterior of the image forming apparatus.

10. The image forming apparatus according to claim 1, wherein the detachable unit is a fixing unit configured to fix a toner image formed on a sheet, to the sheet.

11. The image forming apparatus according to claim 1, wherein the detachable unit is a transfer unit that includes a transfer belt configured to bear a toner image transferred from a photosensitive drum and to be transferred to a sheet.

12. The image forming apparatus according to claim 1, wherein the detachable unit is a process cartridge that includes a photosensitive drum configured to bear an electrostatic latent image, a developing roller configured to develop the electrostatic latent image into a toner image, and a toner storage portion configured to store toner.

13. An image forming apparatus configured to form an image on a sheet, the image forming apparatus comprising:
an apparatus body including an opening portion;
an detachable unit configured to be attached to and detached from the apparatus body via the opening portion;
a door openably and closably supported by the apparatus body and configured to move between a closed position at which the door closes the opening portion and an open position at which the door opens the opening portion; and
a guide member attachably and detachably supported by the door and configured to guide a sheet in a case where the door is positioned at the closed position,
wherein at least a portion of the guide member is configured to overlap with an attachment-and-detachment trajectory of the detachable unit in a state where the guide member is attached to the door positioned at the open position, the guide member being configured to be retracted from the attachment-and-detachment trajectory by the guide member being detached from the door.

14. The image forming apparatus according to claim 13, wherein the door forms a portion of exterior of the image forming apparatus.

15. The image forming apparatus according to claim 13, wherein the detachable unit is a fixing unit configured to fix a toner image formed on a sheet, to the sheet.

16. The image forming apparatus according to claim 13, wherein the detachable unit is a transfer unit that includes a transfer belt configured to bear a toner image transferred from a photosensitive drum and transferred to a sheet.

17. The image forming apparatus according to claim 13, wherein the detachable unit is a process cartridge that includes a photosensitive drum configured to bear an electrostatic latent image, a developing roller configured to develop the electrostatic latent image into a toner image, and a toner storage portion configured to store toner.
